(19) United States
(12) Patent Application Publication
(10) Pub. No.: US 2008/0245198 A1
(43) Pub. Date: Oct. 9, 2008

(54) POWER TOOL WITH A BLADE STORAGE CONTAINER

(75) Inventor: Yasheng Chen, Nanjing (CN)

Correspondence Address: GREENBERG TRAURIG, LLP, 77 WEST WACKER DRIVE, SUITE 2500, CHICAGO, IL, 60601-1732, US

(73) Assignee: CHERVON LIMITED, Kwai Chung (HK)

(21) Appl. No.: 12/021,549

(22) Filed: Jan. 29, 2008

(30) Foreign Application Priority Data
Apr. 5, 2007 (CN) 200720036130.6

(51) Int. Cl. B25G 1/08

(52) U.S. Cl. 81/490

(57) ABSTRACT

A power tool having a housing and a blade storage container. The blade storage container is pivotally mounted on the housing and is disposed between the housing and a handle associated with the housing. The housing has a recess for receiving the container and an elastic member is arranged between the housing and the container.

### BACKGROUND

The following generally relates to a power tool and, more specifically, relates to a power tool with a blade storage container for containing spare cutting tools.

In the art, power tools with a blade storage container are known. By way of example, U.S. Pat. No. 3,353,573 discloses a reciprocating saw with a chamber defined within the housing. The chamber has a cooperating cover and is used to hold interchangeable saw blades. The cover comprises a series of projections and recesses in its one side opposite to the chamber for securing saw blades. The cover is connected to the housing through a latching means and can be completely detached from the housing. U.S. Pat. No. 6,189,217 discloses a saber saw comprising a blade storage chamber defined within the housing for holding spare saw blades. The spare saw blades are disposed in the inner space of the housing.

### SUMMARY

The following describes a power tool that comprises an improved housing and blade storage container. The container is pivotally mounted on the housing around a pivot axis. The housing comprises a first recess for receiving a first end of the container. An elastic member is arranged between the housing and at least a part of the container and a biasing force of the elastic member is substantially perpendicular to the pivot axis of the container.

### BRIEF DESCRIPTION OF THE DRAWINGS

The subject power tool with a storage container will become apparent from the following detailed description and accompanying drawings, wherein:

FIG. 1 is a partial perspective view of an exemplary power tool with an exemplary blade storage container constructed according to a preferred embodiment of the present invention;

FIG. 2 is a schematic view of the power tool of FIG. 1 wherein the cover is detached from the body of the blade storage container;

FIG. 3 is a sectional view of a first exemplary embodiment of a blade storage container; and

FIG. 4 is a sectional view of a second exemplary embodiment of a blade storage container.

### DETAILED DESCRIPTION

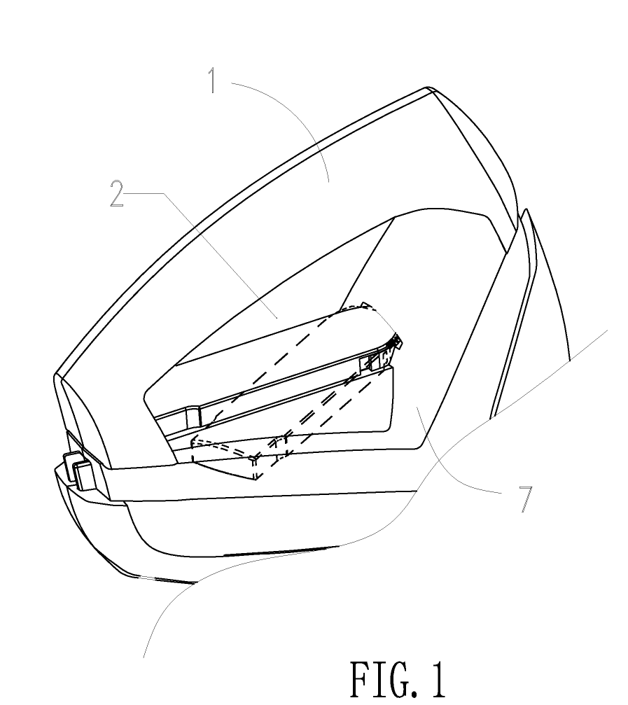

With reference to FIG. 1, a power tool, particularly a jig saw, comprises a housing 7 with a blade storage container 2 mounted thereon. Specifically, the container 2 is positioned under a handle 1 of the jig saw. Therefore, the container 2 will not interfere with the cutting operation or influence the overall size of the jig saw.

In the embodiment illustrated in FIG. 1, the container 2 is pivotally mounted on the housing 7 and is pivotable from a mounting position as indicated by the solid lines to a released position as indicated by the dotted lines. In the released position, the container 2 can be opened to allow for the storing of or the fetching of saw blades.

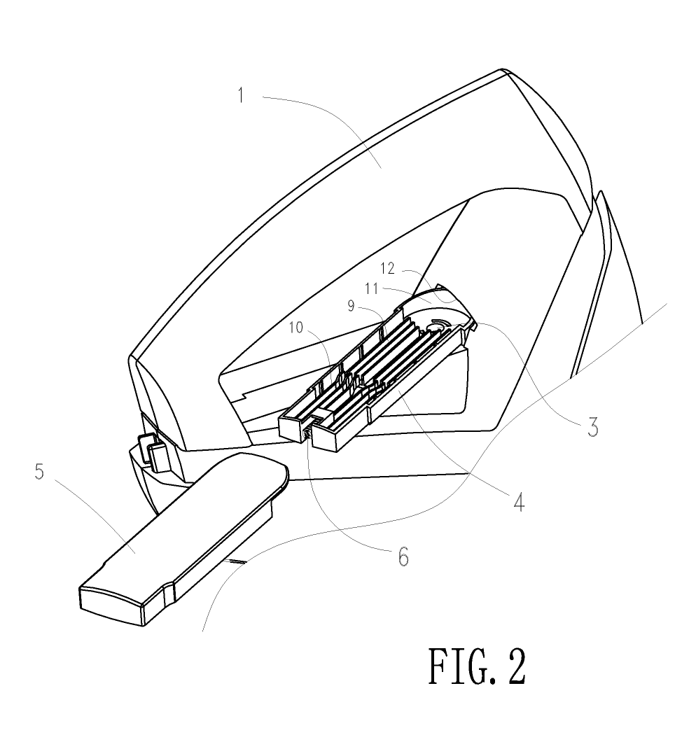

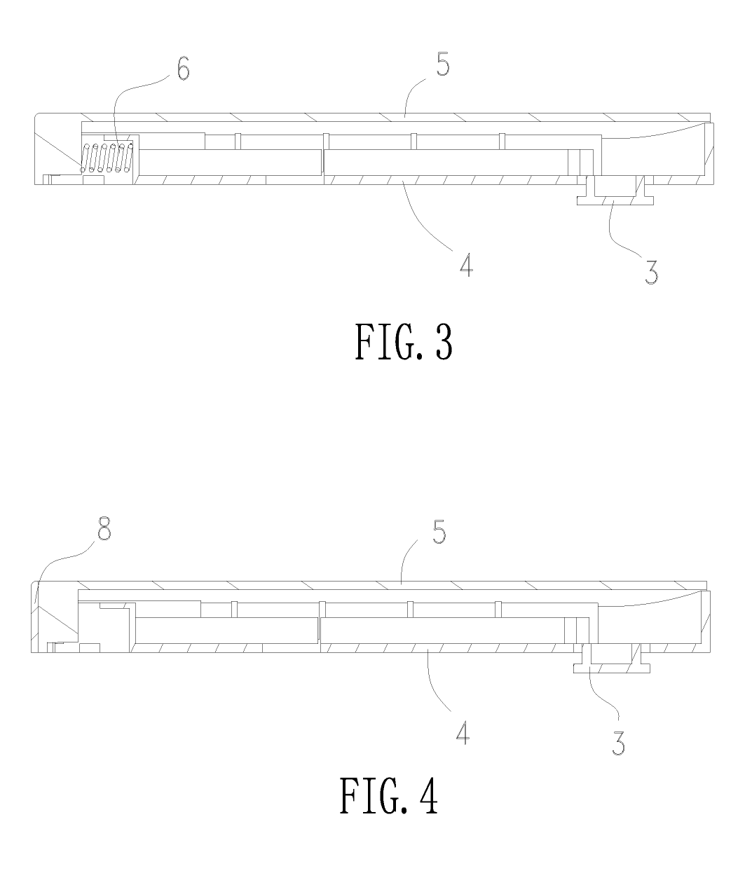

With reference to FIG. 2 and FIG. 3, the blade storage container 2 comprises a body 4 and a cover 5. The cover 5 can be slid along the body 4 and fixed thereon. The body 4 is pivotally mounted on the housing 7 through a pivot axis 3. The body 4 comprises an arcuate wall 11 at its one end. The center of curvature of the arcuate wall 11 is substantially on a center line of the pivot axis 3. The housing 7 is defined with a corresponding arcuate recess 12 adapted for receiving the arcuate wall 11.

The body 4 comprises a series of elongate grooves 9 for receiving the saw blades. Each elongate groove 9 is provided with a corresponding elastic pressing pad 10 for securing the saw blades.

An elastic member is disposed between the body 4 and the cover 5. The elastic member is a spring 6 in the embodiment shown in FIG. 2 and FIG. 3. When the blade storage container 2 is in the mounting position as indicated by the solid lines in FIG. 1, the biasing force of the spring 6 is perpendicular to the pivot axis 3 and biases the cover 5 into a recess (not shown) of the housing 7. When there is a need to release the container 2, the cover 5 is pushed to oppose the biasing force of the spring 6 such that the cover 5 will disengage from the recess whereupon the container 2 may be turned to its released position around the pivot axis 3.

It will be understood that the elastic member between the body 4 and the cover 5 need not be restricted to the spring 6 as shown in FIG. 2 and FIG. 3. Rather, the spring 6 may be replaced by any other appropriate mechanism/device. Furthermore, it will be understood that the position of the elastic member need not be restricted to the embodiment described hereinabove. For example, FIG. 4 shows another embodiment in which the elastic member is an elastic layer 8 attached to the cover 5. The elastic layer 8 may be produced with rubber or other soft material.

The present invention is not restricted as the embodiments disclosed hereinabove. Accordingly, any substitutes and modifications according to the spirit of the present invention will be regarded as falling within the claims appended hereto.

What is claimed is:

1. A power tool, comprising:
a housing;
a blade storage container pivotally connected to the housing around a pivot axis; and
an elastic member disposed between the housing and at least a part of the blade storage container;
wherein a biasing force of the elastic member is substantially perpendicular to the pivot axis of the blade storage container and wherein the housing comprises a first recess for receiving a first end of the blade storage container.

2. The power tool of claim 1, wherein the blade storage container comprises a body and a cover with the body having a series of grooves for receiving saw blades.

3. The power tool of claim 2, wherein the body has a series of securing members for securing the saw blades, each securing member corresponding to respective one of the series of grooves.

4. The power tool of claim 2, wherein the cover is slidably mounted on the body and the elastic member is arranged between the body and the cover.

5. The power tool of claim 4, wherein the biasing force of the elastic member is substantially parallel to a sliding direction of the cover.

6. The power tool of claim 1, wherein the blade storage container comprises a second end having an arcuate wall curvature center which is substantially on the pivot axis, wherein the housing comprises a second recess for receiving the second end of the blade storage container, and wherein the second recess has a shape and a size adapted to match the arcuate wall.

7. The power tool of claim 1, comprising a handle associated with the housing wherein the blade storage container is disposed between the handle and the housing.
